(19) United States
(12) Patent Application Publication
(10) Pub. No.: US 2025/0151718 A1
(43) Pub. Date: May 15, 2025

(54) DEVICES CONTAINING PLANT-SUITABLE ACTIVE INGREDIENTS THAT ARE APPLIED TO THE SOIL OR TO THE AERIAL PARTS OF PLANTS

(71) Applicant: COMPAGNIE GENERALE DES ETABLISSEMENTS MICHELIN, Clermont-Ferrand (FR)

(72) Inventors: MARC SUTTER, Clermont-Ferrand (FR); FRANCOIS JEAN-BAPTISTE-DIT-DOMINIQUE, Clermont-Ferrand (FR); FRANCOISE GRANET, Clermont-Ferrand (FR); SOLENE NIZOU, Clermont-Ferrand (FR); SEVERIN DRONET, Clermont-Ferrand (FR)

(21) Appl. No.: 18/719,998

(22) PCT Filed: Dec. 15, 2022
(86) PCT No.: PCT/FR2022/052377

§ 371 Date: Jun. 14, 2024

(30) Foreign Application Priority Data
Dec. 16, 2021 (FR) 2113693

(51) Int. Cl. A01N 25/18; A01N 25/10; A01N 25/12; A01N 25/22; A01N 57/20

(52) U.S. Cl. CPC A01N 25/18; A01N 25/10; A01N 25/12; A01N 25/22; A01N 57/20

(57) ABSTRACT

A controlled-release formulation comprises a biocompatible and biodegradable copolyester that can be obtained by polycondensation of a diacid and of a polyol, and a phytosanitary active ingredient and/or a biostimulant. A method for treating plants comprises applying a formulation according to the invention to at least part of the plants or to the soil.

### FIELD OF THE INVENTION

The field of the present invention is that of devices containing plant-targeting active ingredients that are applied to the soil or to the aerial parts (leaf system or trunk) of plants, for example stimulants, fertilizers, pesticides, fungicides or nutrients.

The unsuitable use of these products in liquid or solid form causes harmful effects to the plants, contaminates the environment, reduces soil fertility and attacks organisms which should not have been targeted, due to run-off, leaching or volatilization.

Reducing the consumption of fertilizers is an important approach combined with prudent targeted use on the plants in question. Finding effective strategies for the controlled release of active molecules on the plants, in a suitable form, is therefore a major concern in order to limit environmental impact (contamination, soil fertility, climate change (less NOx (N₂O and NO) release), while optimizing expenditure on bio-active molecules (cost reduction) and improving yields and commercial potential.

Among the numerous systems for the controlled release of plant-targeting active products (Trenkel, M. E., Slow- and Controlled-Release and Stabilized Fertilizers: An Option for Enhancing Nutrient Use Efficiency in Agriculture, Second Edition, IFA, Paris, 2010), mention may be made of polymer-coated fertilizers. Nevertheless, this type of fertilizer is known to have release problems; indeed, generally 15 to 30% of the coated fertilizer is not released due to the presence of concentration gradients in the polymer. Systems based on degradable polymers have thus been developed. However, a number of problems remain, such as the toxicity of the degradation products, the speed of degradation, or else the complexity of the systems developed based on polymer blends (Majeed et al., Rev. Chem. Eng. 2015, 31(1), 69-95). Fertilizers employing nutrient nanoparticles have also been envisaged (Gomes, D. G. et al., Advances in Nano-Fertilizers and Nano-Pesticides in Agriculture, Woodhead Publishing, 2021, chap. 5, pages 111-143).

As plant-targeting active ingredients, mention may also be made in particular of plant-stimulating agents for agricultural application, in particular for stimulating heveas such as Hevea brasiliensis.

Latex from heveas such as Hevea brasiliensis is produced by the tree's bark, in particular the latex vessels. Cutting the bark using a process known as tapping makes it possible for the latex to run, making it possible to collect the latex and use it as a raw material for the production of natural rubber. Natural rubber is subsequently converted in order to be used in formulations for rubber items, in particular tyres. The amount of latex collected depends on the frequency of tapping, on the rate at which the tree produces latex, and on the speed with which the tree regenerates latex. The good health of the tree, which gives rise to the quality of the bark and therefore the quality and quantity of latex produced, is therefore of utmost importance.

Consequently, an important concern is to target the sustainable exploitation of heveas in order to ensure the longevity of plantations by limiting stress to the trees associated with tapping, while guaranteeing the conservation of biodiversity and of the local populations who make their living from this crop. Reducing the frequency of tapping is nowadays a widely-adopted technique, which nonetheless causes a drop in latex yield. In order to compensate for this drop in yield, chemical stimulants are applied. The most well-known and widespread is an ethylene generator, (2-chloroethyl)phosphonic acid, known under the name ethephon ((2-chloroethyl)phosphonic acid), which is available for example under the name Ethrel® (Bayer), formulated in aqueous solution.

### PRIOR ART

Documents GB1281524 (1972), GB1320870 (1973), U.S. Pat. No. 4,144,046 (1974), GB1498948 (1978) or BR7506379 (1975) describe aqueous liquid formulations containing ethephon and optionally additives (palm oil, ethanol, propylene glycol, acetic anhydride, fatty alcohols, etc.) serving as stabilizers. These solutions, generally applied using a brush to the trunks of heveas, in particular in the region of the tapping (below or above), enable significant gains in latex yield of 22% (document GB1281524 (1972)) to 64% (document GB1498948 (1978)) over a period of 12 months, compared to controls.

GB1320870 (1973) more specifically describes a composition containing approximately 12% ethephon, 0.08% thickener, 1.6% ethanol, 75% water and palm oil (10%), while BR7506379 (1975) describes a formula composed of 10% ethephon and 90% of a mixture of almond oil, grease, propylene glycol and acetic anhydride. The majority of existing formulations applied to trees consist in diluting concentrated commercial ethephon solutions in water to contents of around one %.

It is also known that, to obtain optimal latex yields, the frequency of stimulation and the concentration of stimulant have to be adjusted depending on the period of the year, on the variety and age of the tree, and on the tapping method.

Ethephon solutions to be applied to hevea trunks have a number of disadvantages both in terms of use and the effect on the trees.

It is necessary to dilute concentrated commercial ethephon solutions in water before applying them to the tree with a brush. This dilution has to be carried out just before application in order to limit premature degradation of the stimulant in the diluted medium, exposing operators to the toxicity and corrosiveness of the product. Controlling the amount of product applied to the bark is also difficult with a technique of application using a brush or spray, and this also leads to product being lost to the environment. Finally, the existing solutions do not enable controlled release over time of the active ingredient into the tree, but rather a process of acute stimulation over a short period of time. Consequently, the actual period of annual stimulation of the trees is low, thus requiring a very regular frequency of application of the stimulant throughout the year (evaluated to be approximately twenty times a year). Moreover, the very humid and rainy climate in tropical and subtropical regions regularly leaches the trunks, causing losses of stimulant solution into the environment, leading both to a reduced stimulatory effect and also to contamination of the nearby environment. The long-term impact of the chemical products constituting ethephon solutions, which are toxic and corrosive to the surrounding nature, the local ecosystem, users and local residents, should not be underestimated.

### SUMMARY OF THE INVENTION

The applicant has developed a formulation comprising both a biobased, biodegradable and biocompatible polymer that exhibits a certain antimicrobial activity, and a stimulant, in particular ethephon. The substance used is poly(glycerol sebacate) or PGS. The PGS substance is harmless to the tree and to the environment. This formulation contains a specific concentration of ethephon and makes it possible to apply, in a targeted manner, a defined amount of stimulant to the tree, limiting losses to the environment due to application techniques and weather conditions. This formulation also enables controlled release of the stimulant over time, ensuring continuous and regular stimulation throughout the year, significantly limiting not only the frequency of tapping but also the frequency of stimulation. Finally, the controlled release enables continuous stimulation of heveas throughout the year, enabling a significant gain in productivity of the plantations compared to plantations stimulated with existing aqueous solutions.

### DESCRIPTION OF THE FIGURES

FIG. 1: Photographs taken during the test of Example 1 (a. composition after 5 days; b. composition after 90 days)

FIG. 2: Photographs taken during the test of Example 1 (a. untreated shrub; b. shrub treated with 2 g of the composition)

FIG. 3: SEC chromatograms of samples of formulations taken during the test Gly=free glycerol, AS=Sebacic Acid The dimers and trimers are oligomers of sebacic acid and glycerol, formed of a sequence of 2 monomeric units and 3 monomeric units, respectively.

### DEFINITIONS

“Biocompatible” means: tolerated by the organism, in particular here tolerated by plants.

“Biodegradable” means: able to be decomposed by living organisms.

For the purposes of the present invention, “biodegradable copolyester” means a copolyester which is biodegradable under the growing conditions, in particular temperature and humidity, of the plants, the treatment of which falls within the scope of the present invention. Preferably, and under these conditions, “biodegradable copolyester” means a copolyester which is more than 80% biodegradable in one year.

Preferably, for the purposes of the present invention, “biodegradable copolyester” means a copolyester which is biodegradable according to standard EN13432.

A phytosanitary product, plant protection product or phytopharmaceutical product is a substance of a mixture of substances of chemical or biological nature (of natural or synthetic origin) used in agriculture, horticulture or forestry to protect cultivated plants from bioaggressors (animal pests, phytopathogenic agents, parasitic plants, weeds) or to optimize crops by promoting the growth of the cultivated plants and by treating their environment (in particular the soil).

“Biostimulant” means a substance which stimulates the nutritional processes of plants independently of the nutrients it contains, with the aim of improving one or more of the following characteristics of the plants or of their rhizosphere: the efficiency of use of the nutrients, tolerance to abiotic stress, qualitative characteristics, the availability of nutrients trapped in the soil or rhizosphere (in accordance with EU Regulation 2019/1009).

Biostimulants may be some natural preparations of no concern. Natural preparations of no concern are:
either natural substances for biostimulant use.
or basic substances.

Basic substances are defined by Article 23 of regulation (EC) 1107/2009. These are substances with phytosanitary benefits but the main use of which is not plant protection (for example in food products).

### SUMMARY OF THE INVENTION

### Detailed Description of the Invention

The invention relates to a controlled-release formulation comprising a biocompatible and biodegradable copolyester that can be obtained by polycondensation of a diacid and of a polyol, and a phytosanitary active ingredient and/or a biostimulant.

### Copolyesters

The formulation according to the invention comprises a biocompatible and biodegradable copolyester that can be obtained by polycondensation of a diacid and of a polyol.

For the purposes of the present invention, “polyol” means an organic molecule comprising at least two alcohol functions.

The copolyesters according to the invention are polyesters composed of at least two different diacid and polyol units.

According to a preferred embodiment, the diacid is selected from aliphatic dicarboxylic acids, preferably (C₃-C₂₀)alkyl diacids, more preferentially (C₈-C₁₅)alkyl diacids.

The diacids are preferentially selected form diacids having two terminal carboxylic acid functions.

The diacid is preferably sebacic acid.

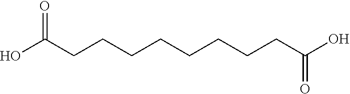 [SMILES: O=C(O)CCCCCCCCC(=O)O]

According to a preferred embodiment, the polyol is selected from diols and triols, preferably from triols; preferentially, the polyol is glycerol.

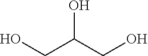

The biocompatible and biodegradable copolyester is advantageously poly(glycerol sebacate) (PGS) and derivatives thereof, more preferentially poly(glycerol sebacate) of the following general formula.

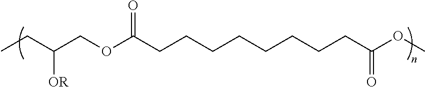

The ratio of polyol monomer:diacid monomer is advantageously between 0.3:1 and 1:0.3.

The poly(glycerol sebacate) can be obtained using a two-step synthesis: a first step of esterification and a second step of polycondensation, and optionally a 3^{rd} step of crosslinking. The first step consists of an esterification reaction between an acid function of the sebacic acid and an alcohol function of the glycerol. Preferentially, the terminal alcohol functions react. The second step consists in growing the chains to obtain a PGS resin.

Next, various strategies can be used to adjust the properties of the polymer, such as a long thermal crosslinking by esterification of the pendent secondary alcohol functions (often at high temperature and low pressure), or crosslinking via post-functionalization (for instance functionalization of the polymer matrix, for instance acrylate or methacrylate functions, then radical crosslinking or crosslinking with isocyanates, for instance hexamethylenediamine diisocyanate). It is also possible to copolymerize the PGS with blocks of other linear polymers, for example with polylactic acid (PLA), poly(lactic-co-glycolic) acid (PLGA), polycaprolactone (PCL) or poly(butyl succinate) (PBS).

For the purposes of the present invention, all these compounds are brought together under the name poly(glycerol sebacate) and derivatives thereof.

The biocompatible and biodegradable copolyester is preferably biobased. In this case, it may be obtained from renewable raw materials resulting from biomass.

The formulation according to the invention advantageously comprises 1% to 99% by weight, preferably 2% to 98% by weight, more preferably still 3% to 96%, particularly preferably 5% to 95% by weight, of a biocompatible and biodegradable copolyester that can be obtained by polycondensation of a diacid and of a polyol.

In one embodiment of the invention, the biocompatible and biodegradable copolyester is in elastomeric form, i.e. it has elastic properties after crosslinking.

In one embodiment of the invention, the formulation advantageously comprises residual monomers which have not been incorporated in the chains of the biocompatible and biodegradable copolyester (diacid and/or polyol), at contents of <90% by weight, more preferably still <80% by weight, preferably <70% by weight.

### Phytosanitary Products

The formulation according to the invention preferably comprises a phytosanitary active ingredient and/or a biostimulant selected from the group consisting of stimulants, fertilizers, pesticides, fungicides, nutrients, bactericides, insecticides, growth regulators.

The formulation according to the invention preferably comprises a phytosanitary active ingredient and/or a biostimulant which is an ethylene precursor, preferentially ethephon.

Advantageously, the formulation according to the invention relates to a formulation wherein the biocompatible and biodegradable copolyester is poly(glycerol sebacate) (PGS) and the phytosanitary and/or biostimulant active ingredient is ethephon.

The formulation according to the invention advantageously comprises 1% to 99% by weight, preferably 2% to 98% by weight, particularly preferably 5% to 95% by weight, of a phytosanitary active ingredient and/or a biostimulant.

The formulation according to the invention advantageously comprises 5% to 95% by weight of ethephon.

The formulation according to the invention advantageously comprises 0.1% to 99% by weight, preferably 0.5% to 95% by weight, particularly preferably 1% to 90% by weight of water.

### Additives

The formulation according to the invention may comprise one or more additive(s) selected from the group consisting of stabilizers, compatibilizers, shaping agents, agents for regulating the release of the active ingredient, antioxidants.

### Form

The formulation according to the invention may be in the form of a paste, patch, granules or a solution for spraying, preferably in the form of a paste.

When the formulation according to the present invention is in the form of a paste, the formulation according to the invention advantageously comprises 20% to 80% by weight, preferably 30% to 70% by weight, more preferably still 40% to 70% by weight, of a biocompatible and biodegradable copolyester that can be obtained by polycondensation of a diacid and of a polyol.

When the formulation according to the present invention is in the form of a solution for spraying, the formulation according to the invention advantageously comprises 1% to 50% by weight, preferably 2% to 40% by weight, more preferably still 3% to 30% by weight, of a biocompatible and biodegradable copolyester that can be obtained by polycondensation of a diacid and of a polyol.

When the formulation according to the present invention is in the form of granules, the formulation according to the invention advantageously comprises 50% to 99% by weight, preferably 60% to 98% by weight, more preferably still 70% to 97% of a biocompatible and biodegradable copolyester that can be obtained by polycondensation of a diacid and of a polyol.

When the formulation according to the present invention is in the form of a paste, it advantageously comprises 1% to 50% by weight, preferably 2% to 40% by weight, particularly preferably 3% to 30% by weight of water.

When the formulation according to the present invention is in the form of a solution for spraying, it advantageously comprises 50% to 99% by weight, preferably 60% to 98% by weight, particularly preferably 70% to 97% by weight of water.

When the formulation according to the present invention is in the form of granules, it advantageously comprises 0.1% to 30% by weight, preferably 0.2% to 20% by weight, particularly preferably 0.3% to 10% by weight of water.

### Preparation Process

Various methods for formulating the copolyester with the phytosanitary active ingredient and/or the biostimulant can be used. Mention may be made, nonlimitingly, of mixing molten copolyester with the phytosanitary active ingredient and/or the biostimulant in solution, for example in aqueous solution.

This mixing can be carried out in a conventional stirred reactor at relatively mild temperatures in order to limit the risks of the phytosanitary active ingredient and/or the biostimulant degrading, preferably <120° C., preferably <110° C., preferably <100° C., using conventional spindles or Ultra-Turrax-type shearing spindles, limiting the contact time. The mixing method can be batchwise, semi-continuous or continuous.

### Application Method

According to one embodiment, the formulation according to the invention is intended to be applied to the trunks of shrubs and trees, in particular when it is in the form of a paste, patch or solution for spraying.

Another subject of the invention relates to a method for treating plants, comprising applying a formulation according to the invention to at least part of the plants, preferably one or more aerial part(s), or to the soil.

When the formulation according to the present invention is in the form of a paste, patch or solution for spraying, it is preferentially applied to at least part of the plants, preferably one or more aerial part(s).

According to one embodiment, the method for treating plants according to the invention relates to trees and shrubs, and the formulation is applied to the trunk.

The trees or shrubs are preferentially selected from the group consisting of heveas, vines, olive trees, fruit trees and ornamental plants, preferably heveas.

When the formulation according to the present invention is in the form of a paste, it is preferentially tacky and can be spread using a spatula or using an application device of the caulking gun type, enabling the application of a controlled amount to the plant.

It is also possible to envisage a device composed of a “hard” layer in contact with a “tacky” layer, of the type of a patch pre-cut to suitable dimensions. It may be attached to one or more aerial plant part(s), for example to the trunk or for example to the leaves or fruit.

When the formulation according to the present invention is in the form of granules, it will be applied to the soil.

The following examples illustrate the invention without limiting the scope thereof.

### EXAMPLES

### Size Exclusion Chromatography (SEC) Analysis Method:

The PGS samples were dissolved in THF to a concentration of approximately 1.5 g·l⁻¹, then stirred for 2 hours before being injected.

The analytical conditions used are described in the table below:

| Eluent | THF | |
|---|---|---|
| Injection volume | 100 | μl |
| Concentration | ~1.5 | g/l |
| Temperature | 35° | C. |
| Detector | RI Waters | |
| Flow rate of mobile phase | 1 | ml/min |

| | |
|---|---|
| Columns | 2 Mixed D + 2 Mixed E |
| Calibration | Polystyrene (PS) |

The analysable mass range is between 162 g/mol and 7 500 000 g/mol. The number-average molecular weight (Mn) is expressed in g/mol as PS equivalents; similarly, the weight-average molecular weight is expressed in g/mol as PS equivalents. The polydispersity D is defined by the relationship Mw/Mn.

### Method for Measuring Free Ethephon in the Composition

Free ethephon is analysed by ¹³C NMR. A Bruker AVANCE III 500 MHz spectrometer fitted with a BBFO 5 mm z-gradient cryogenic probe makes it possible to detect samples solvated in acetone-d₆ with calibration at 29.9 ppm. The free ethephon signals are measured at 38.2 ppm (ClCH₂, s), and at 31.7 ppm (CH₂P, d, ¹J=133 Hz).

All the monomers (glycerol (99.5%) and sebacic acid (99%)) and the stimulant (ethephon) are commercially available and were used without additional purification. The ethephon solution used is a commercially available aqueous solution (Ethrel®) concentrated to around 480 g/l of ethephon, i.e. approximately 42% by weight of ethephon.

### Example 1: Test of Ageing of the Formulation According to the Invention without Active Ingredient, on Heveas (Hevea brasiliensis)

### Synthesis of PGS:

A sample of PGS was prepared by mixing 3 molar equivalents of glycerol (230 g) with 1 molar equivalent of sebacic acid (169 g) and water (72 g) in a 500 ml reactor topped with a distillation column and a condenser connected to a distillate receiver. The mixture is brought to 130° C. for 24 h at atmospheric pressure under an inert atmosphere (N₂), the water is recovered in the distillate receiver. Finally, the medium is placed under vacuum (5 mbar) at the same temperature for one hour. The PGS obtained has the following characteristics: Mn=860 g/mol, Mw=1020 g/mol, D=1.2.

Formulation and implementation of a composition without active ingredient on a hevea trunk:

The PGS obtained is either used as is or mixed with water in a stirred reactor at 30° C. for 15 min. Preparations with water contents of 0.1% and 5% were thus obtained. The composition is in the form of a paste at ambient temperature. Finally, approximately 2 g of the composition were deposited on the trunk of a hevea using a spatula, under representative conditions (temperature, humidity, watering).

### Test of Ageing of the Composition:

A composition without additional water was monitored over 3 months, with photographs being taken, samples being collected and analysis being performed by size exclusion chromatography (SEC) in order to verify the change in the substance under real conditions, and the biodegradable nature of the substance.

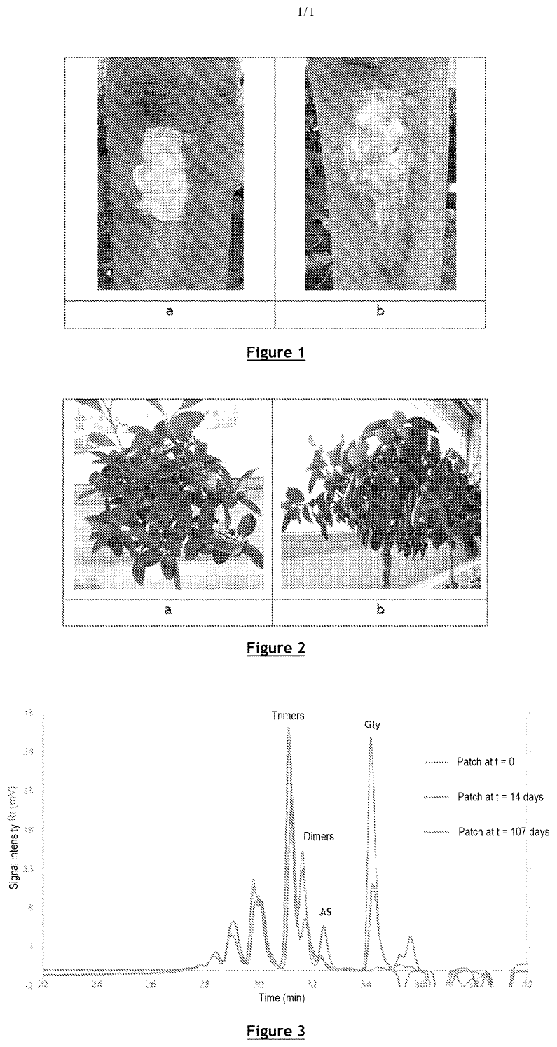

As can be seen on the photographs of FIG. 1, a significant change in the appearance of the patch is observed between 90 days and 5 days of testing, with the disappearance of a significant amount of substance.

As can be seen on the superimposed SEC chromatograms (FIG. 3) of 3 samples collected at t=0 days (initial state), 14 days and 107 days, a significant reduction in the free glycerol content, the appearance of sebacic acid, and a reduction in the dimeric and trimeric oligomer signals are observed, confirming hydrolysis (and leaching) of the copolyester. In conclusion, a resistance of the layer after 3 months is observed which is associated with the phenomenon of biodegradation.

### Example 2: Test of Stimulation of Calamondins (Citrus Microcarpa) with a Formulation According to the Invention Comprising Ethephon

### Synthesis of PGS:

A sample of PGS was prepared by mixing 3 molar equivalents of glycerol (230 g) with 1 molar equivalent of sebacic acid (169 g) and water (72 g) in a 500 ml reactor topped with a distillation column and a condenser connected to a distillate receiver. The mixture is brought to 130° C. for 24 h at atmospheric pressure under an inert atmosphere (N₂), the water is recovered in the distillate receiver. Finally, the medium is placed under vacuum (5 mbar) at the same temperature for one hour. The PGS obtained has the following characteristics: Mn=860 g/mol, Mw=1020 g/mol, D=1.2.

### Formulation of the Composition:

The PGS obtained (9.1 g) is placed in a reactor at 30° C. for 15 minutes, with stirring. An aqueous solution of ethephon concentrated to 480 g/l, i.e. 42% by weight of ethephon, is added dropwise to the medium (1.9 ml, i.e. 0.9 g of ethephon). The composition is stirred for an additional 5 minutes in order to obtain a homogeneous paste containing 8% by weight of ethephon, 11% by weight of water, and 81% by weight of PGS.

### Application of the Composition to the Plant:

Finally, the composition is applied at different amounts to the trunks of calamondins bearing green fruit, using a spatula (2 g, i.e. approximately 160 mg of ethephon, and 5 g, i.e. approximately 400 mg of ethephon).

Two controls were carried out:

Control 1=shrub without treatment; Control 2=above composition deposited on an inert surface (aluminium plate).

### Aims:

Observe stimulation of fruit ripening
Collect samples over time to measure the ethephon content in the paste
Monitor the plant-stimulating activity

### Results:

As can be seen in FIG. 2, after 15 days:
Untreated shrub (Control 1): no significant change
Shrub treated with 2 g: all the fruits are orange (ripe)

The ethephon content decreases significantly after 15 days in the paste applied to the shrubs (more than 80% reduction in concentration), much less in Control 2 (composition deposited on inert surface, with a decrease in ethephon concentration of less than 50%).

1.-15. (canceled)

16. A controlled-release formulation comprising a biocompatible and biodegradable copolyester that can be obtained by polycondensation of a diacid and of a polyol, and a phytosanitary active ingredient and/or a biostimulant.

17. The controlled-release formulation according to claim 16, wherein the diacid is selected from aliphatic dicarboxylic acids.

18. The controlled-release formulation according to claim 16, wherein the biocompatible and biodegradable copolyester is poly(glycerol sebacate) (PGS).

19. The controlled-release formulation according to claim 1, wherein the phytosanitary and/or biostimulant active ingredient is selected from the group consisting of stimulants, fertilizers, pesticides, fungicides and nutrients.

20. The controlled-release formulation according to claim 19, wherein the phytosanitary and/or biostimulant active ingredient is ethephon.

21. The controlled-release formulation according to claim 1, wherein the biocompatible and biodegradable copolyester is poly(glycerol sebacate) (PGS) and the phytosanitary and/or biostimulant active ingredient is ethephon.

22. The controlled-release formulation according to claim 1, further comprising one or more additives selected from the group consisting of stabilizers, compatibilizers, shaping agents, agents for regulating the release of the active ingredient, and antioxidants.

23. The controlled-release formulation according to claim 1, wherein the controlled-release formulation is in the form of a paste, patch, granules or a solution for spraying.

24. The controlled-release formulation according to claim 1, wherein the controlled-release formulation comprises 1% to 99% by weight of the biocompatible and biodegradable copolyester that can be obtained by polycondensation of a diacid and of a polyol.

25. The controlled-release formulation according to claim 1, wherein the controlled-release formulation comprises 1% to 99% by weight of the phytosanitary active ingredient and/or biostimulant.

26. The controlled-release formulation according to claim 25, wherein the controlled-release formulation comprises 5% to 95% by weight of ethephon.

27. The controlled-release formulation according to claim 1, further comprising 0.1% to 99% by weight of water.

28. A method for treating plants comprising applying the controlled-release formulation according to claim 1 to at least part of the plants or to the soil.

29. The method for treating plants according to claim 28, wherein the plants are trees or shrubs, and the controlled-release formulation is applied to a trunk.

30. The method for treating plants according to claim 28, wherein the biocompatible and biodegradable copolyester is poly(glycerol sebacate) (PGS) and the phytosanitary and/or biostimulant active ingredient is ethephon.
